(19) United States
(12) Patent Application Publication
(10) Pub. No.: US 2004/0149742 A1
(43) Pub. Date: Aug. 5, 2004

(54) System to heat liquids

(76) Inventor: Ricardo Andres Lescano, Buenos Aires (AR)

Correspondence Address: Sanchelima and Associates, P.A., Jesus Sanchelima, Esq., 235 S.W. Le Jeune Rd., Miami, FL, 33134, US

(21) Appl. No.: 10/353,715

(22) Filed: Jan. 30, 2003

(51) Int. Cl. H05B 6/80

(52) U.S. Cl. 219/688

(57) ABSTRACT

A system to heat liquids. A liquid, such as water, is heated by microwave energy. A housing assembly comprises a plurality of magnetrons, which may be arranged in a vertical manner. Conduit, which allows the water to flow therethrough, is secured within the housing. Incoming cold water enters the housing assembly through a first one-way valve and the conduit. The conduit coils within the housing assembly and the water is heated within the conduit by the magnetrons when producing microwave energy. Outgoing hot water exits the housing assembly through the conduit and a second one-way valve, which accommodates the flow of hot water therethrough. The magnetrons are controlled by thermostats, which maintain an outgoing water temperature at a predetermined level.

### BACKGROUND OF THE INVENTION

1. Field of the Invention

The present invention relates to heating systems, and more particularly, to systems that heats liquids with electromagnetic energy.

2. Description of the Related Art

Typical systems to heat liquids, such as conventional domestic water heaters, use electrical resistor elements, gas or oil-burners to heat water. With these system types, a substantial amount of the generated heat is inefficiently wasted. Waste of energy is increasingly undesirable due to increased energy costs.

Many designs for heating liquids have been designed in the past. None of them, however, include magnetrons having conduit surrounding them, whereby a liquid, such as water, flows through the conduit, and the magnetrons heat said liquid.

Applicant believes that the closest reference corresponds to U.S. Pat. No. 5,387,780 issued to Riley for Microwave Hot Water Heating System. However, it differs from the present invention because Riley teaches an apparatus and method for heating water using a microwave powered boiler. The apparatus consists of a three cabinet arrangement, which permits the dry incorporation of wave-guides and the tunneling of microwave energy completely around and into a seamless water chamber. The apparatus can be adapted to provide a hydronic heating system, a forced hot air heating system, a tankless domestic hot water supply and a hot water heater.

Additionally, Applicant believes that a close reference corresponds to U.S. Pat. No. 4,593,169 issued to Thomas for Water Heater. However, Thomas teaches a water heater in which water is heated by microwave energy, whereby a tank that holds water, is separated by a horizontal partition into a relatively small upper chamber and a larger lower chamber. Incoming cold water enters the upper chamber and is heated by a magnetron, which produces microwave energy. A transfer conduit accommodates the flow of hot water from the upper chamber to the lower chamber when water is discharged from the lower chamber through an outlet pipe. When the water in the lower chamber cools, a pump returns it to the upper chamber for reheating. The pump and magnetron are controlled by thermostats, which maintain the water in the upper and lower chambers at different temperature levels.

Most conventional domestic water heaters using electrical resistant elements, gas or oil-burners to heat water, typically have a holding tank where water is stored at predetermined temperature levels, regardless of whether there is a demand for heated water or not.

Other patents describing the closest subject matter provide for a number of more or less complicated features that fail to solve the problem in an efficient and economical way. None of these patents suggest the novel features of the present invention.

### SUMMARY OF THE INVENTION

The instant invention employs electromagnetic energy to heat liquids, such as water. The instant invention may supply a continuous supply of heated water at predetermined temperature levels as a water heater.

More specifically, the instant invention is a system for heating liquids with electromagnetic energy comprising a housing assembly having first and second ends. The first end has an inlet for supplying incoming liquids thereto and an outlet for supplying outgoing liquids therefrom. The housing assembly has conduit means with third and fourth ends, the third end is attached to the inlet and the fourth end is attached to the outlet.

The instant invention has means for applying the electromagnetic energy to the conduit means to raise the temperature of the liquids within the conduit means, when the temperature of the liquids is below a predetermined temperature level.

Sensing means sense the temperature of the liquids in the outlet. The sensing means include a plurality of thermostats secured within the outlet.

A frame assembly is secured in between the first and second ends and is attached to the means for applying the electromagnetic energy for stabilization.

The instant invention also comprises engaging means to engage the applying means when the temperature sensed by the sensing means is below the predetermined level, and disengaging means to disengage the applying means when the temperature sensed by the sensing means is above the predetermined level.

The inlet has a pressure regulator and a first one-way valve for the incoming liquids. The outlet has a second one-way valve for the outgoing liquids. The pressure regulator has a switch. In the closed position, the switch transmits electrical power for the engaging and disengaging means when the liquids flow through the inlet, and in the open position, the liquids do not flow through the inlet.

The conduit means trespass the means for applying the electromagnetic energy, enabling a reduction in operating temperature of the means for applying the electromagnetic energy with the liquids within the conduit means. In the preferred embodiment, the conduit means are coiled within the housing assembly.

The liquids may be water, a detergent, and even a lubricant.

It is therefore one of the main objects of the present invention to provide an efficient system to heat water with microwave energy.

It is another object of this invention to provide a system to heat liquids, that heats liquids within, only when there is a flow of such liquid.

It is still another object of the present invention to provide a system to heat liquids that is compact.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of the instant invention.

FIG. 2 shows a cut view of the present invention taken along the line 2-2 of FIG. 1.

FIG. 3 is an electrical schematic of the instant invention.

### DETAILED DESCRIPTION OF THE PREFERRED EMBODIMENT

Referring now to the drawings, where the present invention is generally referred to with numeral 10, it can be observed that it basically includes housing assembly 20, magnetron assembly 60, and frame assembly 90.

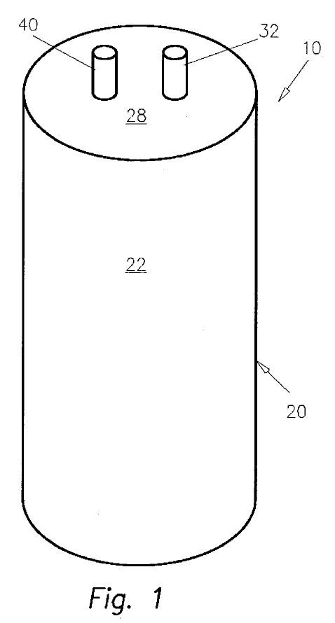

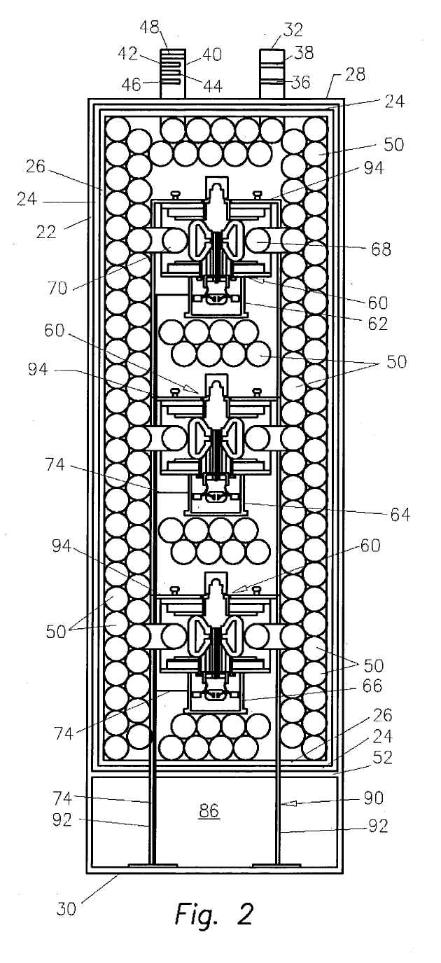

As seen in FIG. 1, numeral 10 generally designates a water heater constructed in accordance with the present invention. The water heater 10 has a housing assembly 20, which includes an outer shell 22 formed of sheet metal or a similar material. Housing assembly 20 preferably has a cylindrical shape, although it may have a rectangular shape or any other desired configuration. Water heater 10 has two ends, defined by wall 28 and wall 30, seen in FIG. 2. Outwardly extending from wall 28 are inlet pipe 32 and outlet pipe 40. In alternate embodiments, housing assembly 20 may be supported by a plurality of underlying legs.

As seen in FIG. 2, spaced inwardly from the outer shell 22 is a lining 26, which has substantially the same shape as outer shell 22 but a somewhat smaller size. Insulation 24 is interposed between outer shell 22 and lining 26. Lining 26 is preferably formed from a material which is resistant to corrosion and which also reflects microwave electromagnetic energy. Alternatively, lining 26 may be formed from glass, which is backed by metal in order to reflect microwaves.

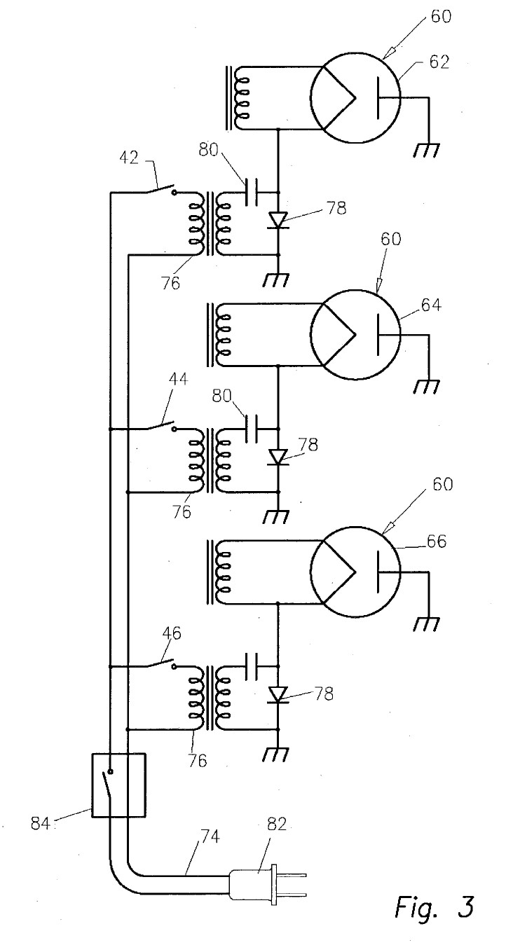

Outwardly extending from wall 28, is inlet pipe 32. Inlet pipe 32 forms an inlet into housing assembly 20, for supplying incoming cold water that is to be heated. Inlet pipe 32 attaches to conduit 50 and is equipped with a pressure regulator 38 and one-way valve 36. Pressure regulator 38 connects to switch 84, seen in FIG. 3. Switch 84 is open when water does not flow through pressure regulator 38. When pressure regulator 38 senses water flow therethrough, switch 84 closes to thereby activate instant invention 10.

Therefore, instant invention 10 heats water only when there is a flow of water through the invention. Therefore, if a household hot water faucet is in the open position, causing water to flow, the instant invention 10 will operate to maintain predetermined water temperature levels. In the event there is not a flow of water through the invention, the instant invention 10 will not operate. This feature is especially efficient, since no water heating expenses are incurred when heated water is not demanded; such as when families are away from their household during the day, on weekends, while on vacation, or otherwise any other time when not desired as an example.

Conduit 50, as a single continuous conduit, coils downwardly within housing assembly 20, through magnetrons 62; 64; and 66 of magnetron assembly 60. Specifically, conduit 50 enters inlet 68 and exits outlet 70 of each magnetron 62; 64; and 66. Conduit 50 continues coiling downwardly towards wall 52, and then coils upwardly within housing assembly 20, finally attaching to outlet pipe 40. Conduit 50 is preferably formed of a substance that is resistant to corrosion and yet conducts microwave energy. Conduit 50 coils through magnetrons 62; 64; and 66, to enable water flowing through conduit 50 to cool the magnetrons, thus lowering their operating temperatures and affording great heat reduction efficiency.

The water in conduit 50 is heated by electromagnetic microwave energy generated by magnetrons 62; 64; and 66, of magnetron assembly 60. The magnetrons 62; 64; and 66 are secured onto frame assembly 90. Frame assembly 90 has elongated members 92 secured onto wall 30. In an alternate embodiment, elongated members 92 may be secured onto wall 52. Extending from elongated members 92 are connectors 94. Connectors 94 attach to magnetrons 62; 64; and 66 for magnetron stabilization. Magnetron assembly 60 is supplied with electric current by wiring, secured onto frame assembly 90, that extends through a suitable conduit 74 from electrical box 86. Electrical box 86 contains all the typical electrical components necessary to operate instant invention 10. Such typical electrical components may include, but are not limited to, transformers 76, diodes 78, and capacitors 80, as seen in FIG. 3. The magnetrons 62; 64; and 66 are conventional and operate to produce microwaves within housing assembly 20. The microwaves strike conduit 50 and may reflect off of the walls, floors and ceiling of housing assembly 20 in order to heat the water contained within conduit 50. Since the water only travels through conduit 50, the operating components of magnetron assembly 60 are suitably shielded from the water.

Three thermostats control magnetron assembly 60. More specifically, magnetrons 62; 64; and 66 and controlled by thermostats 42; 44; and 46 respectively. Thermostats 42; 44; and 46 each have a temperature sensor located within outlet pipe 40 to sense the water temperature therein. The sensors for the three thermostats are located apart from one another at discrete locations, which are vertically separated from one another, as shown.

Hot water is discharged from water heater 10 through an outlet pipe 40, located adjacent to inlet pipe 32. Outlet pipe 40 extends to connections with the hot water distribution system of a structure that contains water heater 10.

FIG. 3 illustrates the manner in which the thermostats control the operation of the magnetrons 62; 64; and 66. A plug 82, which can be connected with an ordinary electrical outlet or other power source, supplies current to conduit 74. Each thermostat 42; 44; and 46 is open when it senses a water temperature above the level set for each thermostat. Each thermostat 42; 44; and 46 closes when it senses a water temperature below each respective thermostat setting.

Magnetrons 62; 64; and 66 are connected across conduit 74 and are arranged in series with their respective thermostats 42; 44; and 46. Thermostat 42 is open when it senses a water temperature above that set for this thermostat. When the sensed temperature is below the thermostat setting, thermostat 42 closes to thereby activate magnetron 62. In the preferred embodiment, thermostat 42 opens to deactivate magnetron 62 when the water temperature in outlet pipe 40 is approximately above 90 degrees Centigrade.

Thermostat 44 is open when it senses a water temperature above that set for this thermostat. When the sensed temperature is below the thermostat setting, thermostat 44 closes to thereby activate magnetron 64. In the preferred embodiment, thermostat 44 opens to deactivate magnetron 64 when the water temperature in outlet pipe 40 is approximately above 95 degrees Centigrade.

Thermostat 46 is open when it senses a water temperature above that set for this thermostat. When the sensed temperature is below the thermostat setting, thermostat 46 closes to thereby activate magnetron 66. In the preferred embodiment, thermostat 46 opens to deactivate magnetron 66 when the water temperature in outlet pipe 40 is approximately above 100 degrees Centigrade.

In operation, switch 84 is normally closed, indicating that the water is flowing through pressure regulator 38, and conduit 50 is filled with water. When heated water is desired in the structure and a hot-water faucet is opened, water flows through instant invention 10. As described above, thermostats 42; 44; and 46 activate magnetrons 62; 64; and 66 respectively to produce microwave energy, which heats the water within conduit 50. The magnetrons remain activated so long as the temperature of the water in outlet pipe 40 remains below the respective settings of thermostats 42; 44; and 46. When the water temperature in outlet pipe 40 is sufficient to satisfy each setting for thermostats 42; 44; and 46, each thermostat opens to deactivate its respective magnetron.

When the hot-water faucet is opened hot water flows out of outlet pipe 40 and the outgoing hot water is replaced by incoming cold water from a source through inlet pipe 32. Valve 48, seen in FIG. 2, prevents outgoing hot water from flowing back into conduit 50. It should be understood that the water heater 10 can be equipped with conventional items such as a sacrificial anode, pressure relief fitting and other devices commonly used in domestic water heaters.

In alternate embodiments, instant invention 10 may be utilized to warm or heat water for pools, showers, and hot tubs, as an example. In other alternate embodiments, instant invention 10 may be utilized to warm or heat cleaning solutions for the cleaning of vehicles, carpets, and clothes, as an example. In yet other alternate embodiments, instant invention 10 may be utilized to warm or heat lubricants for heating systems as an example.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A system for heating liquids with electromagnetic energy comprising:
A) a housing assembly having first and second ends, said first end having an inlet for supplying incoming liquids thereto and an outlet for supplying outgoing said liquids therefrom, said housing assembly having conduit means with third and fourth ends, said third end attached to said inlet and said fourth end attached to said outlet;
B) means for applying said electromagnetic energy to said conduit means to raise the temperature of said liquids within said conduit means when the temperature of said liquids is below a predetermined temperature level;
C) sensing means to sense said temperature of said liquids in said outlet, said sensing means includes a plurality of thermostats secured within said outlet; and
D) a frame assembly secured between said first and second ends attached to said means for applying said electromagnetic energy for stabilization.

2. The system for heating liquids with electromagnetic energy set forth in claim 1, further comprising engaging means to engage said applying means when said temperature sensed by said sensing means is below said predetermined level.

3. The system for heating liquids with electromagnetic energy set forth in claim 2, further comprising disengaging means to disengage said applying means when said temperature sensed by said sensing means is above said predetermined level.

4. The system for heating liquids with electromagnetic energy set forth in claim 3, wherein said inlet has a pressure regulator and a first one-way valve for said incoming liquids and said outlet has a second one-way valve for said outgoing liquids.

5. The system for heating liquids with electromagnetic energy set forth in claim 4, wherein said pressure regulator has a switch, said switch in the closed position for transmitting electrical power for said engaging and disengaging means when said liquids flows through said inlet, and said switch in the open position when said liquids does not flow through said inlet.

6. The system for heating liquids with electromagnetic energy set forth in claim 5, wherein said conduit means trespasses said means for applying said electromagnetic energy enabling a reduction in operating temperature of said means for applying said electromagnetic energy with said liquids within said conduit means.

7. The system for heating liquids with electromagnetic energy set forth in claim 6, wherein said conduit means are coiled within said housing assembly.

8. The system for heating liquids with electromagnetic energy set forth in claim 7, wherein said liquids are water.

9. The system for heating liquids with electromagnetic energy set forth in claim 7, wherein said liquids is a detergent.

10. The system for heating liquids with electromagnetic energy set forth in claim 7, wherein said liquids is a lubricant.
